(19) United States
(12) Patent Application Publication
(10) Pub. No.: US 2026/0005929 A1
(43) Pub. Date: Jan. 1, 2026

(54) AUTOMATED DATA CENTER SYSTEM FOR PROFILE GENERATION

(71) Applicant: DISH Wireless L.L.C., Englewood, CO (US)

(72) Inventors: Siddhartha Chenumolu, Ashburn, VA (US); Mehdi Alasti, Arlington, VA (US)

(21) Appl. No.: 18/754,994

(22) Filed: Jun. 26, 2024

(51) Int. Cl. H04L 41/14; H04L 41/16

(52) U.S. Cl. CPC H04L 41/145; H04L 41/16

(57) ABSTRACT

A data center system and method for profile generation for a telecommunications infrastructure is provided. The data center system includes a data port to receive, from a component of a core network in a telecommunications infrastructure, data that is based on wireless communications of wireless devices over a radio access network in the telecommunications infrastructure. A controller of the data center system controls, when the port receives the data, an artificial intelligence model to perform an analysis on the data. The controller further generates, from a result of the analysis, a profile for a geographic region in the radio access network.

### BACKGROUND

In a wireless communication infrastructure, such as a cellular network, a radio access network can provide wireless communication coverage throughout adjacent coverage areas of a geographic region. Expansion or densification of the wireless communication coverage in areas of the geographic region can result in improved connectivity to the radio access network, which is an overall improvement to the radio access network. When expanded or densified, the improved wireless communication coverage in the radio access network can also facilitate business development and growth opportunities in those coverage areas where the expansion or densification of wireless communication coverage has occurred.

### BRIEF DESCRIPTION OF THE DRAWINGS

The accompanying drawings, which are incorporated in and form a part of this specification, illustrate examples of the disclosure and, together with the description, explain principles of the examples.

FIG. 1 illustrates an example of a telecommunications infrastructure.

FIG. 2 illustrates an example of a radio access network.

FIG. 3 is a flowchart that illustrates an example of predictive processing and profile generation.

FIG. 4 illustrates an example profile of a geographic region in a radio access network.

In the drawings, like reference symbols and numerals indicate the same or similar components. Like elements in the various figures are denoted by like reference symbols and numerals for consistency. Unless otherwise indicated, like elements and method steps are referred to with like reference numerals.

### DETAILED DESCRIPTION OF THE INVENTION

The following describes technical solutions in this specification with reference to the accompanying drawings.

Computer-generated profiles of a geographic region in a radio access network can provide valuable insight into coverage areas of the geographic region. A core network in the wireless communication infrastructure can, in real-time, capture and coalesce data pertaining to the usage of the radio access network. A system in a data center or the core network itself can request the data from a component of the core network. Upon receipt of the data, the system can execute an artificial intelligence model that analyzes the data automatically and without any human intervention. The system can convert, into a computer-generated profile of the geographic region, a result of the analysis performed by the artificial intelligence model over multiple cycles. The profile may indicate classifications and information about users of wireless devices in the radio access network and/or about locations in the geographic region of the radio access network visited by users of the wireless devices.

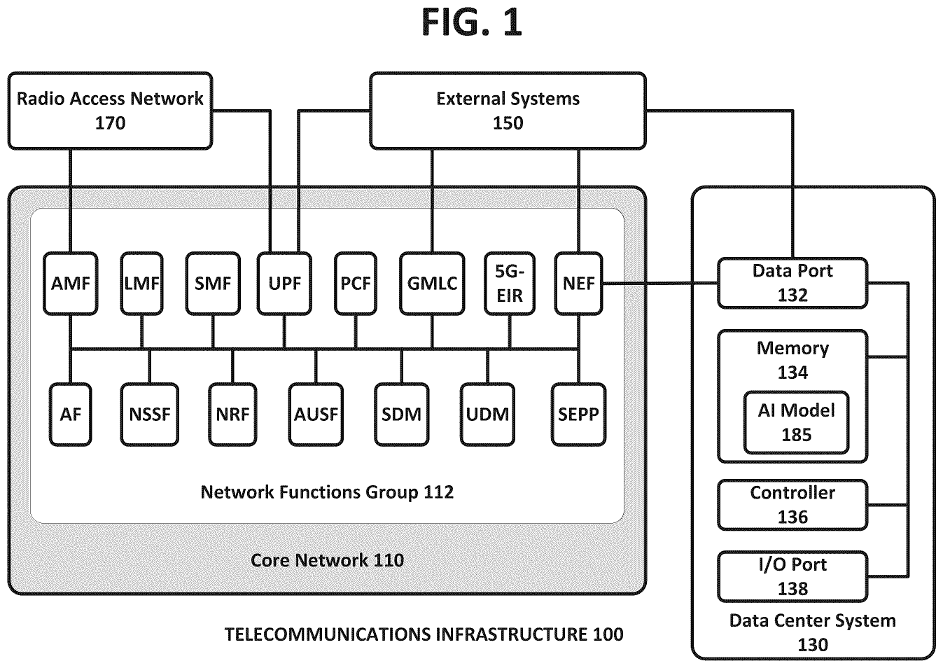

FIG. 1 illustrates an example telecommunications infrastructure 100. The telecommunications infrastructure 100 may include a core network 110, a data center system 130, external systems 150, and a radio access network 170.

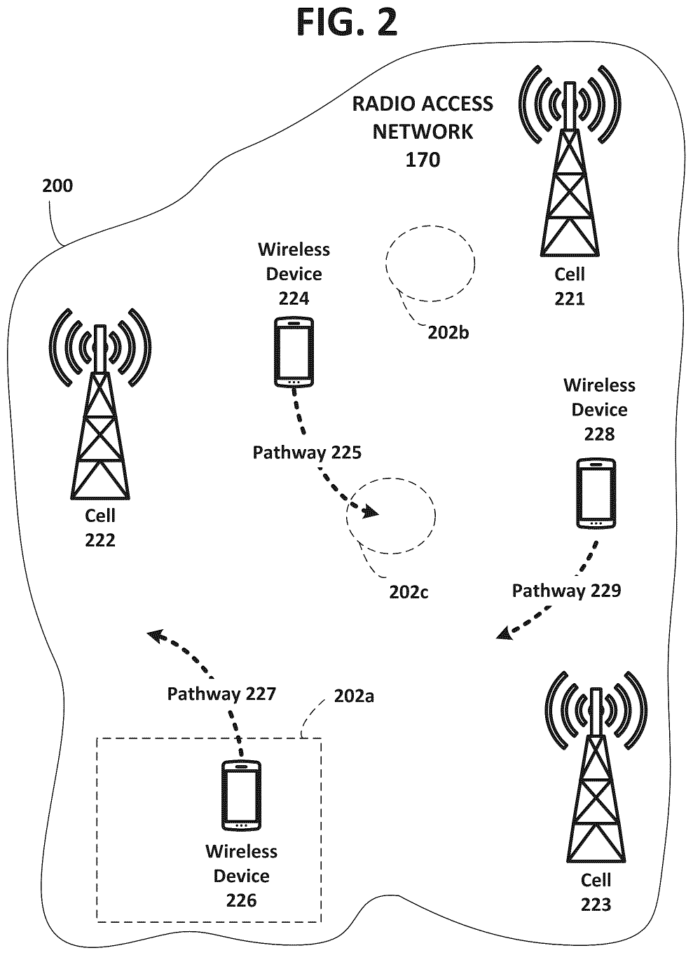

FIG. 1 illustrates an example core network 110. The core network 110 may manage and facilitate wireless communication between the radio access network 170, the external systems 150, and user equipment (see, e.g., wireless devices of FIG. 2). The core network 110 may communicate electronically with the external systems 150, the data center system 130, the radio access network 170, any of the cells in the radio access network 170, and any user equipment that is in wireless communication with any cell of the radio access network 170.

The core network 110 may be a facility that is sited in a building at a geographic location and/or sited in a plurality of buildings across multiple geographic locations. A service provider may own, operate, maintain, and upgrade the core network 110. The service provider may be a company, business, an organization, and/or another entity. The core network 110 is a telecommunications infrastructure that may deliver a variety of services to any user equipment that is in wireless communication with the radio access network 170. These services may include, but are not limited to, voice calls, text messaging, internet access, video conferencing, multimedia content delivery, and other services.

Components of the core network 110 may comprise a combination of routers, switches, and servers. The facility may contain the routers, switches, servers, and other hardware equipment required for processing electronic information and distributing the electronic information throughout the core network 110.

The core network 110 may comprise hundreds or thousands of the routers, switches, and servers. Each of the routers, switches, and servers may electronically communicate with any others of the routers, switches, and servers in the core network 110. For example, each of the routers, switches, and servers in the core network 110 may be individually identifiable by a unique IP address. The respective IP address for any of the routers, switches, and servers in the core network 110 may differ from the IP address for any other routers, switches, and servers in the telecommunications infrastructure 100.

A server on the core network 110 may be a virtual server, a physical server or a combination of both. The virtual server may be in the form of software that is running on a server in the core network 110. The physical server may be hardware in the core network 110.

The user equipment, when accessing the servers, may receive downloadable information from the servers. This downloadable information may include, but is not limited to, graphics, media files, software, scripts, documents, live streaming media content, emails, and text messages. The servers may provide a variety of services to user equipment. The variety of services may include web browsing, media streaming, text messaging, and online gaming.

The core network 110 may comprise a network functions group 112 that enables the core network 110 to control the routing of information throughout the telecommunications infrastructure 100. The network functions group 112 may be a group of individual servers. The network functions group 112 may be software-based, with each network function in the network functions group 112 being a microservice. The microservice may be a piece of software code.

As will be explained in detail, the network functions group 112 may comprise a variety of network functions that control and manage the core network 110. Interoperability between the network functions of network functions group 112 may exist. FIG. 1 illustrates some of the network functions in the network functions group 112. Those skilled in the art will appreciate that there may be other network functions in the core network 110 that are not shown in FIG. 1.

The core network 110 may authenticate any user equipment that attempts to access the core network 110. The Authentication Server Function (AUSF) may primarily manage the authentication processes and procedures for ensuring that any user equipment is authorized to connect with and access the core network 110.

The core network 110 may authorize any user equipment to access the core network 110. The Access and Mobility Management Function (AMF) is responsible for the management of communication between the telecommunications infrastructure 100 and any user equipment. This management may include the authorization of access to the telecommunications infrastructure 100 by any user equipment. Other responsibilities for the AMF may include mobility-related functions such as handover procedures that allow any user equipment to remain in communication with the telecommunications infrastructure 100 while traversing throughout a geographic region. The handover procedures may include, but are not limited to, tracking the physical location of any user equipment while the user equipment roams between different geographic areas in the radio access network 170 and managing handovers of the user equipment between various cells in the radio access network 170.

The Location Management Function (LMF) manages location information for user equipment that is communication with the radio access network 170. When managing the location information for the user equipment, the LMF may track the physical location of any user equipment in the radio access network 170 when the user equipment moves from one cell in the radio access network 170 to another cell in the radio access network 170.

The User Plane Function (UPF) is responsible for establishing a data path between the external systems 150 and any user equipment. When the radio access network 170 transfers packets of information between the core network 110 and any user equipment, the UPF may manage the routing of the packets between the radio access network 170 and the external systems 150.

The Session Management Function (SMF) is primarily responsible for establishing, modifying, and terminating sessions for any user equipment. A session is the presence of electronic communication between the core network 110 and the respective user equipment. The SMF may manage the allocation of an IP address to any user equipment.

The Subscriber Data Management (SDM) function enables the core network 110 to deliver personalized service to each subscriber to the core network 110. For each subscriber to the core network 110, the SDM may store and manage information related to each subscriber. The information may include, but is not limited to, the identity of each subscriber, authentication credentials for each subscriber, billing information for each subscriber, profiles for each subscriber, the subscription information for each subscriber, and the preferences of each subscriber.

The Unified Data Management (UDM) function maintains information for subscribers to the core network 110. The subscriber may include an entity who is subscribed to a service that the core network 110 provides. The entity may be a person that uses any user equipment. The entity be any user equipment. The information for the subscribers may include, but is not limited to, the identities of the subscribers, the authentication credentials for the subscribers, and any service preferences that the core network 110 is to provide to the subscribers.

The Network Slice Selection Function (NSSF) is primarily responsible for selecting and managing network slices. Network slicing is the creation of multiple virtual networks within the core network 110. Each virtual network is a network slice. When selecting a network slice, the NSSF may determine which virtual network is best suited for a particular service or application. When managing the network slice, the NSSF may allocate available network resources of the core network 110 to the network slice. These network resources may include bandwidth, processing power, and other resources of the core network 110.

Application Function (AF) is responsible for managing application services within the core network 110. For example, the AF may support network slicing by managing and controlling application services within each network slice.

The Policy Control Function (PCF) is responsible for establishing, terminating, and modifying bearers. A bearer is a virtual a communication channel between the core network 110 and any user equipment. This communication channel is a path through which data is transferred between the core network 110 and any user equipment.

The Gateway Mobile Location Center (GMLC) is an interface between the core network 110 and location-based services that are external to the core network 110. The GMLC may provide, to the location-based services, the location information for user equipment that is communication with the radio access network 170.

The Network Exposure Function (NEF) is responsible for enabling interactions between the core network 110 and authorized services and/or applications that are external to the core network 110. The NEF may leverage an application programming interface (API) to interact with the authorized services and/or applications on a near real time basis. The API may deliver, to the authorized services and/or applications, any data required for the interactions. The service provider may charge for the data accordingly.

These interactions, when enabled by the NEF, may lead to the development of innovations that may improve the capabilities of the core network 110.

The NF Repository Function (NRF) maintains profiles for each of the network functions in the core network 110. The profiles for a network function may include information about capabilities, supported services, and other details that are relevant for the network function.

The 5G-Equipment Identity Register (5G-EIR) function is a database that stores information about each user equipment that is connected to the core network 110. This information may include unique identifiers for identifying user equipment. A unique identifier may be an International Mobile Equipment Identity (IMEI) number.

A Security Edge Protection Proxy (SEPP) function facilitates the secure interconnection within the telecommunications infrastructure 100.

Each of the network functions group 112, databases, and proxies may be individually identifiable by a unique IP address. A network operator may assign the IP addresses for the network functions group 112. The respective IP address for any of the network functions in the network functions group 112 may differ from the IP address for any other network function, database, and/or proxy in the core network 110. Each of the network functions, databases, and proxies may electronically communicate with any others of the network functions, databases, and proxies in the core network 110. However, the IP addresses for the network functions, databases, and proxies in the core network 110 may be private IP addresses that are not publicly accessible.

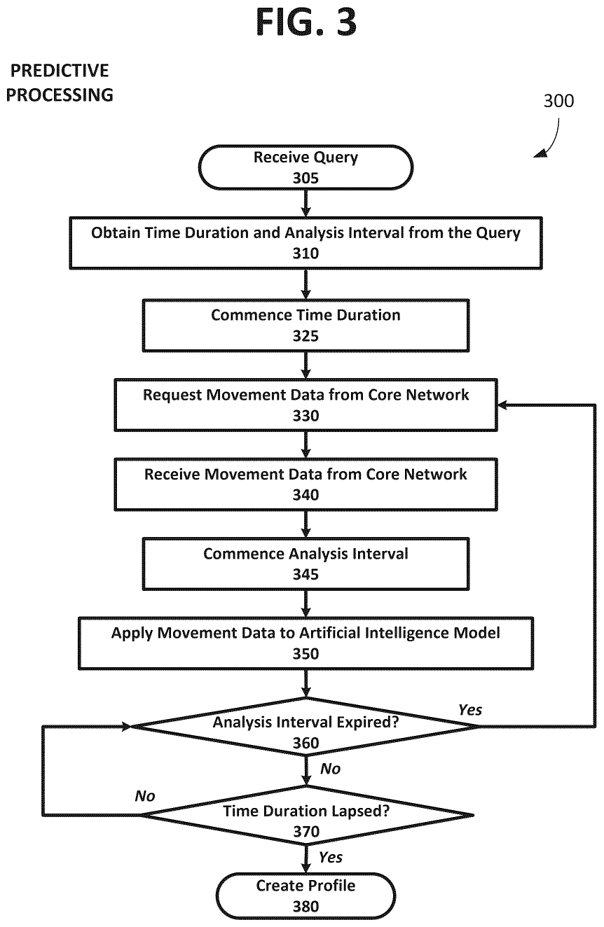

FIG. 1 illustrates an example data center system 130. The data center system 130 may be responsible for monitoring and managing the predictive processing and profile generation of FIG. 3. The data center system 130 may be identifiable by a unique IP address. The IP address for data center system 130 may differ from any other IP address in the telecommunications infrastructure 100. The data center system 130 may sited in a building at a geographic location and/or sited in a plurality of buildings across multiple geographic locations.

In some examples, the data center system 130 is an edge device in the telecommunications infrastructure 100 (e.g., in a breakout edge data center (BEDC) or other edge device). Although illustrated as separate from the core network 160, in some examples, the data center system 130 is integrated into the core network 160 (e.g., into one or more servers therein), in whole or in part.

As illustrated in FIG. 1, the data center system 130 is a physical apparatus that may include a data port 132, memory 134, a controller 136, and an I/O port 138. Those skilled in the art will appreciate that there may be additional infrastructure in the data center system 130 that is not shown in FIG. 1.

The data port 132 may include electronic circuitry that allows the data center system 130 to electronically communicate by wire with the external systems 150. The data port 132 may encrypt information prior to electronically communicating the encrypted information to the external systems 150. The data port 132 may decrypt information that the data port 132 receives from the external systems 150. The data port 132 may also encrypt the information prior to electronically communicating the encrypted information to the core network 110. The data port 132 may decrypt information that the data port 132 receives from the core network 110.

Memory 134 may be a non-transitory processor readable or computer readable storage medium. Memory 134 may comprise read-only memory (“ROM”), random access memory (“RAM”), other non-transitory computer-readable media, or a combination thereof. Memory 134 may be any electronic, magnetic, optical, or other physical storage device that stores executable instructions and/or data. Memory 134 may store filters, rules, data, or a combination thereof.

The memory may store an artificial intelligence model 185. The artificial intelligence model 185, also referred to as a trained artificial intelligence (AI) model, may be a machine learning model that has been trained to classify data to characterize information about users of wireless devices and/or locations in which the wireless devices are within a geographical area associated with a radio access network. The artificial intelligence model 185 may be or may implement, for example, decision tree learning prescribed by user intent, association rule learning, an artificial neural network (e.g., a convolutional neural network, a generative adversarial network), inductive logic programming, support vector machine, clustering, Bayesian network, reinforcement learning, representation learning, similarity and metric learning, sparse dictionary learning, and genetic algorithms. The machine learning model can be trained with training data and using known methods such as supervised learning, self-supervised learning, semi-supervised learning, etc. Through the training, weights and interconnections between nodes of the model may be altered and refined to improve the accuracy or functioning on the model. As one example, to perform supervised learning, the training data includes example inputs (e.g., example sets of data) and corresponding desired (for example, actual) outputs (e.g., classifications of data to characterize information about users of wireless devices and/or locations in which the wireless devices are within a geographical area associated with a radio access network), and the machine learning model progressively develops a model that maps inputs to the outputs included in the training data. As another example, to perform self-supervised learning, a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Through the training, the weights and interconnections between nodes of the model may be altered and refined.

As will be explained in detail, the controller 136 may control the circuitry of the data center system 130 and the operations performed by the data center system 130. The controller 136 may execute the artificial intelligence model 185 to implement the functionality of the artificial intelligence model 185 described herein. The controller 136 may also execute additional program instructions stored and retrieved from the memory 184 to implement other functionality of the controller 136 and/or the data center system 130 described herein. The controller 136 may be hardware that is implemented as any suitable processing circuitry including, but not limited to at least one of a microcontroller 136, a microprocessor, a single processor, and a multiprocessor. The controller 136 may include at least one of a video scaler integrated circuit (IC), an embedded controller 136 (EC), a central processing unit (CPU), a graphics processing unit (GPU), an accelerated processing unit (APU), an application specific integrated circuit (ASIC), field programmable gate arrays (FPGA), or the like, and may have a plurality of processing cores.

The I/O port 138 may include any apparatus that permits a person to interact with the data center system 130. The apparatus may include a keyboard, a touchscreen, and/or a graphical user interface (GUI). The apparatus may include a voice user interface (VUI) that enables interaction with the data center system 130 through voice commands. The apparatus may comprise mechanical switches, buttons, and knobs. The I/O port 138 may include any other apparatus, circuitry and/or component that permits the person to interact with the data center system 130.

The external systems 150 may include public or private data networks, servers, and online services that allow for the distribution of information. The external systems 150, via the networks, servers, and/or online services thereof, may provide or include third party video streaming platforms, gaming platforms, file repositories, email services, and the like.

A public or private data network may comprise or be part of a data bus, a wired or wireless information network, a public switched telephone network, a satellite network, a local area network (LAN), a wide area network (WAN), and/or the Internet. The external systems 150 may facilitate the transfer of information in the form of packets. Each of these packets may comprise small units of data. The external systems 150 may interact with the Network Exposure Function (NEF) and the User Plane Function (UPF) in the core network 110.

Components of the external systems 150 may comprise a combination of routers, switches, and servers. Each of the routers, switches, and servers may be individually identifiable by a unique IP address. The respective IP address for any of the routers, switches, and servers may differ from the IP address for any other routers, switches, and servers in the external systems 150. The external systems 150 may comprise hundreds or thousands of routers, switches, and servers. Each of the routers, switches, and servers may electronically communicate with any others of the routers, switches, and servers. Those skilled in the art will appreciate that there may be infrastructure in the external systems 150 that is not shown in FIG. 1.

Servers on the external systems 150 may be indirectly accessible by any user equipment. A server may be a virtual server, a physical server, or a combination of both. The physical server may be hardware in a facility that is sited in a building at a geographic location. Each facility may contain the routers, switches, servers, and other hardware equipment required for processing electronic information and distributing the electronic information throughout the external systems 150. The virtual server may be in the form of software that is running on a server in the external systems 150. Those skilled in the art will appreciate that there may be additional infrastructure in the external systems 150 that is not shown in FIG. 1.

FIG. 2 illustrates an example radio access network 170 in a geographic region 200. The radio access network 170 in the example of FIG. 2 may be a segment of a 4G network, a segment of a 5G network, a segment of a 6G network, or the like. Components of the radio access network 170 may include a number of distributed cells 221, 222, 223. Any of the cells 221, 222, 223 may be a macrocell, a microcell, a picocell, a femtocell, and/or other component that enables the transmission of signals between the core network 110 and any wireless device 224, 226, 228. Those skilled in the art will appreciate that there may be infrastructure in the radio access network 170 that is not shown in FIG. 2.

For the example of FIG. 2, movement of a wireless device 224 in the radio access network 170 is along a pathway 225. Another wireless device 226 in FIG. 2 may travel in the radio access network 170 along another pathway 227. Movement of a different wireless device 228 in the radio access network 170 is along yet another pathway 229 in FIG. 2. For simplicity and ease of understanding, FIG. 2 shows a case in which only three cells 221, 222, 223 are present in the radio access network 170. However, the number of cells in the radio access network 170 may vary depending on the architecture of the radio access network 170. For example, the radio access network 170 may typically include more than three cells, if not hundreds or thousands of cells.

Any cell 221, 222, 223 may be a cell in the radio access network 170. Each cell 221, 222, 223 may electronically communicate directly or indirectly with any other cell 221, 222, 223 and may communicate electronically with the core network 110. Specifically, each cell 221, 222, 223 in the radio access network 170 may be individually identifiable by a unique Internet Protocol (IP) address. An IP address for any cell differs from the IP address for any other cell. Any cell may be of a same radio access type or may be of different radio access type as any other cell. Each of the cells 221, 222, 223 may provide overlapping communication coverage for the geographic region 200 in the radio access network 170.

The overall coverage of the radio access network 170 may extend beyond the geographic region 200, thus potentially covering other geographic regions. Additionally, the particular size and shape of the geographic region 200 may vary, and is shown in FIG. 2 as an example for illustration purposes. Also within the geographic region 200 are locations 202a, 202b, and 202c, which may be referred to individually or may be referred to collectively as the locations 202. Each of the locations 202 may be a respective facility, campus, government property, business, or the like defined by an address (e.g., a street address), a boundary defined in terms of map coordinates (e.g., latitude and longitude), or a combination thereof. For example, location 202a may be a park, location 202b may be a government post office, and location 202c may be a restaurant.

As illustrated in FIG. 2, the cells 221, 222, 223 are each an electronic apparatus that may facilitate wireless communication between a core network 110 and any wireless device. To facilitate wireless communication between wireless device and the radio access network 170, any cell 221, 222, 223 may wirelessly connect any wireless device to the core network 110.

Any wireless device 224, 226, 228 in FIG. 2 may be user equipment. The user equipment may be any electronic device with a wireless modem that compatible with the radio access network 170. For example, the user equipment may be a tablet, a telephone, a mobile phone, a smartphone, an appliance, a modem, a laptop, a computing device, a television set, a set-top box, a digital video recorder (DVR), a wireless access point, a router, a gateway, a network switch, a set-back box, a control box, a television converter, a television recording device, a media player, an Internet streaming device, a mesh network cell, and/or any other electronic device that is configured to wirelessly communicate with any cell. The user equipment may be a stationary electronic device. The user equipment may be a portable electronic device that is capable of wireless communicate with the radio access network 170 during transit of the user equipment from one location in the geographic region to any other location in the geographic region.

For simplicity and ease of understanding, the example of FIG. 2 shows a case in which only three wireless devices 224, 226, 228 may communicate with the radio access network 170. However, the number of wireless devices that may communicate with the radio access network 170 may vary depending on the architecture of the radio access network 170. For example, more than three wireless devices may typically communicate with the radio access network 170, if not hundreds or thousands of wireless devices may simultaneously communicate with the radio access network 170. The total amount of wireless devices in the radio access network 170 may vary depending on the number of wireless devices that are connected to the radio access network 170. Each wireless device in communication with the radio access network 170 may be individually identifiable by a unique IP address. An IP address for any wireless device differs from the IP address for any other wireless device.

Turning to FIG. 3, a process 300 for predictive processing and profile generation is illustrated. The process 300 is described as being carried out by the data center system 130 and in conjunction with the telecommunications infrastructure 100 described above. For example, the controller 136 of the data center system 130 (e.g., based on executing machine-readable instructions stored in the memory 134) may execute the process 300. However, in some embodiments, the process 300 is implemented by another system and/or in conjunction with another telecommunications infrastructure. Additionally, although the blocks of the process 300 are illustrated in a particular order, in some embodiments, one or more of the blocks may be executed partially or entirely in parallel, may be executed in a different order than illustrated in FIG. 3, or may be bypassed.

The predictive processing of the process 300 may analyze and predict activities that may improve the overall performance the radio access network 170, maintain the functioning of the radio access network 170, and increase information known about usage of the radio access network 170. The controller 136, when executing the process 300, may generate a profile of a geographic region (also referred to as a regional profile) in the radio access network 170. The regional profile may provide an overview of the geographic region for the radio access network 170. As will be explained in detail, the regional profile may include classifications and information about users of wireless devices in the radio access network, including demographics information, and/or about locations in the geographic region of the radio access network visited by users of the wireless devices. An example of such a geographic region, wireless devices, radio access network, and locations are provided in FIG. 2 as the geographic region 200, wireless devices 224, 226, 228, the locations 202, and the radio access network 170. In some examples, the regional profile may further include performance metrics and other information that may be pertinent to the performance of the radio access network 170.

The I/O port 138 in block 305 of FIG. 3 may receive, from a requester, a query that requests the regional profile for the geographic region in the radio access network 170. The requestor may be a person, a company, business, an organization, an electronic device, or other entity. The controller 136 in block 305 may control the I/O port 138 to receive the query. The I/O port 138 may receive the query from a user interface. A person may input the query manually into the user interface by navigating and manipulating the user interface. The user interface may include a graphical user interface (e.g., displayed by a display screen). The user interface may include a series of mechanical switches, buttons, touch screen sensor (e.g., integrated into the display screen), and knobs to enable the user interface to receive the query from the person. The controller 136 may advance from block 305 to block 310.

The controller 136 in block 310 may extract an analysis interval from the query. The analysis interval is the span of time between request for, or receipt by the data port 132 of, respective batches of movement data from a component of the core network 110, as described further below. The analysis interval may be a fraction of a second, a second, tens of seconds, a minute, etc. In block 310 of FIG. 3, the controller 136 may also extract a time duration from the query. The time duration is the total amount of time for the controller 136 to assess movement throughout the geographic region of user equipment (one or more wireless devices) in communication with the radio area network. The time duration may be an hour, multiple hours, a day, or longer. When the controller 136 extracts the time duration from the query, the controller 136 may advance from block 310 to block 320. In some examples, an analysis interval is not obtained, although the analysis interval may be implicitly present as a result of the timing of receipt of batches of movement data.

In block 325, the controller 136 may commence measuring the time duration. For example, the controller 136 may initiate a timer and track an elapsed time based on a real time clock associated with the data center system 130. The controller 136 may advance from block 325 to block 330.

In block 330, the controller 136 may configure the data port 132 to send a command to a component of the core network 110. For example, the controller 136 may transmit, via the data port 132, the command. Configuring the data port 132 to send the command may control the data port 132 to electronically connect the data center system 130 with the component of the core network 110. The command may request the component of the core network 110 to output a batch of movement data to the data port 132. The component may be one or more of the functions of the functions group 112. For example, when the data center system 130 is external to the core network 110, the controller 136 may transmit the command to the NEF function of the core network. The NEF function in the network functions group 112 may assist with the transfer of the command from the data center system 130 to the core network 110 and may assist with the transfer of the batch from the core network 110 to the data center system 130. For example, the NEF function may transmit the request to appropriate function(s) of the network functions group 112 to obtain the batch of movement data for output to the data center system 130. In examples where the data center system 130 is integrated into the core network 110, the controller 136 may communicate the command to one or more of the other network functions of the network functions group 112 to request that that function(s) output the batch of movement data (or portions thereof).

The movement data in the batch may include data that is based on wireless communications of wireless devices over the radio access network 170. More particularly, the movement data in the batch may include identity data, device type data, tracking data, data type data, and demographics data for each wireless device that is in communication with the radio access network 170. The core network 110 may acquire such identity data, device type data, tracking data, data type data, and demographics data for each wireless device.

The identity data may include information that identifies a particular user equipment (e.g., identifiers that each uniquely identify one of the wireless device that communicated in the radio access network 170). The device type data may include information that identifies the device type for the user equipment (e.g., a model number). The tracking data may include information related to the transit of the user equipment within the radio access network 170 from one location in the geographic region to any other location in the geographic region. For example, the tracking data may indicate a current location of the user equipment, a previous location of the user equipment, and/or a rate of change and/or direction of movement of the user equipment. The tracking data may be collected and provided by the LMF function and/or GMLC function, for example. The tracking data may further indicate, as part of the current or previously location, location information pertaining to the locations, for example, a type of business, building, government service, transportation service, facility, or land area associated with the location. Accordingly, the tracking data may indicate whether a user is at a post office, a bank, a restaurant, a park, a train station, for example. This location information may provided by components of the core network 110 based on information obtained from third party services (e.g., of the external systems 150) and/or the data center system 130 may separately access such location information from an accessible repository (e.g., maintained by the data center system 130 and/or third party services of the external systems 150). The data type data may indicate the type of data being communicated to or from the user equipment, such as, for example, video streaming data, voice call data, gaming data, email data, or the like. The demographics data may include information that pertains to the demographics of the user of the user equipment. For example, the demographics data may indicate a gender, age, ethnicity, income level, education level, occupation, the marital status, household size, or the like of the user of the user equipment that is in communication with the radio access network 120. The demographics data may be provided by the user equipment to the core network 160 and/or may be accessible by the core network 160 via a subscriber information database associated with the core network 160.

The movement data in the batch may also include performance metrics for the radio access network 170. The performance metrics may include, but are not limited to, packet loss information, data throughput information, network latency information, and/or other metrics information that may quantify the performance of the radio access network 170. Network latency information is a measure of the round-trip time from for data packets to travel from a cell to any user equipment that is in wireless communication with the radio access network 170. Data throughput information is a measure of the data transfer rate between the cell and the user equipment. Packet loss information is a measure of the reliability of data transmission between the cell and the user equipment.

When the controller 136 configures the data port 132 to send the command to the core network 110 in block 330, the controller 136 may advance from block 330 to block 340.

In block 340 of FIG. 3, the data port 132 may receive the batch of movement data from the component of the core network 110. When the data port 132 receives the batch, the controller 136 may advance from block 340 to block 345.

In block 345, the controller 136 may commence measuring the analysis interval. For example, the controller 136 may initiate an analysis interval timer and track an elapsed time based on a real time clock associated with the data center system 130. The controller 136 may advance from block 345 to block 350.

In block 350 of FIG. 3, the controller 136 may apply the batch of movement data to the artificial intelligence model (e.g., to the artificial intelligence model 185). In response to applying the batch of movement data, the artificial intelligence model may perform an analysis of the batch of movement data. The artificial intelligence model may analyze a separate batch of movement data during each cycle of the iterative loop. As a consequence of the analysis interval and processing time of the artificial intelligence model being shorter than the time duration, the controller 136 may apply multiple batches of the movement data to the machine learning model during successive cycles of the processing in FIG. 3 prior to the expiration of the time duration. The controller 136 may in block 350 advance the processing in FIG. 3 from block 350 to block 360 when the controller 136 applies the movement data in the batch to the machine learning model to the artificial intelligence model.

In block 360 of FIG. 3, the controller 136 may determine whether or not the analysis interval has expired. Expiration of the analysis interval may occur when the elapsed amount of time from block 345 to block 360 of FIG. 3 is greater than the analysis interval. When the controller 136 determines in block 360 that the analysis interval has expired, the controller 136 may return from block 360 to block 330. When the controller 136 determines in block 360 that the analysis interval has not expired, the controller 136 may advance from block 360 to block 370.

In some examples, block 345 is bypassed and, in block 360, rather than determine whether the analysis interval has expired, the controller 136 determines whether processing of the batch of movement data by the artificial intelligence model 185 has completed. When the processing has completed, the controller 136 returns to block 330 to request the next batch of movement data. When the processing has not yet completed, the controller 136 proceeds to block 370.

In block 370 of FIG. 3, the controller 136 may determine whether or not the time duration has lapsed. A lapse of the time duration may occur when the elapsed amount of time from block 325 to block 370 of FIG. 3 is greater than the time duration.

When the controller 136 determines in block 370 that the time duration has not yet lapsed, the controller 136 may return from block 370 to block 360. The controller 136 may establish the iterative loop in the processing of FIG. 3 by returning from block 370 to block 360 followed by the controller 136 in block 360 returning to block 330. As a consequence of the analysis interval being substantially shorter than the time duration, controller 136 may execute multiple cycles of the iterative loop.

While in the iterative loop, the controller 136 may repeatedly execute the sequence of blocks 330, 340, 345, 350, 360 and 370 until the controller 136 determines in block 370 that the time duration has lapsed. During each cycle of the iterative loop, the core network 110 may update the movement data and provide the updated the movement data to the data port 132 as an updated batch of movement data. While in the iterative loop, the controller 136 controls the data port 132 to receive the updated batch from the core network 110 and apply the updated batch to the machine learning model. When the controller 136 determines in block 370 that the time duration has lapsed, the controller 136 may terminate the iterative loop and advance from block 370 to block 380.

In block 380 of FIG. 3, the controller 136 may convert, into the regional profile for the geographic region in the radio access network 170, a result of the analysis produced by the artificial intelligence model 185 over multiple cycles in the process 300. For example, in each iteration of block 350, the artificial intelligence model 185 may output a classification of the batch of the movement data analyzed, with each such output being a subset of the information that makes up the regional profile. The subset of information from each iteration (e.g., for each analysis interval) may be temporarily stored in the memory 134 after being output, and then the controller 136 may combine the subsets of information in block 380 to generate the regional profile. For example, the subsets of information may include quantities or values for each type of information that makes up the regional profile, and these quantities or values may be summed by the controller 136 to provide the information for the time duration.

The controller 136 may store or transmit the regional profile generated in block 380. For example, the controller 136 may transmit or output the regional profile for display on a display screen via an I/O port 138, may transmit to an external device of the external systems 150 via the data port 132, or may transmit to a wireless device in communication with the radio access network 170. Additionally or alternatively, the controller 136 may store the regional profile in the memory 134.

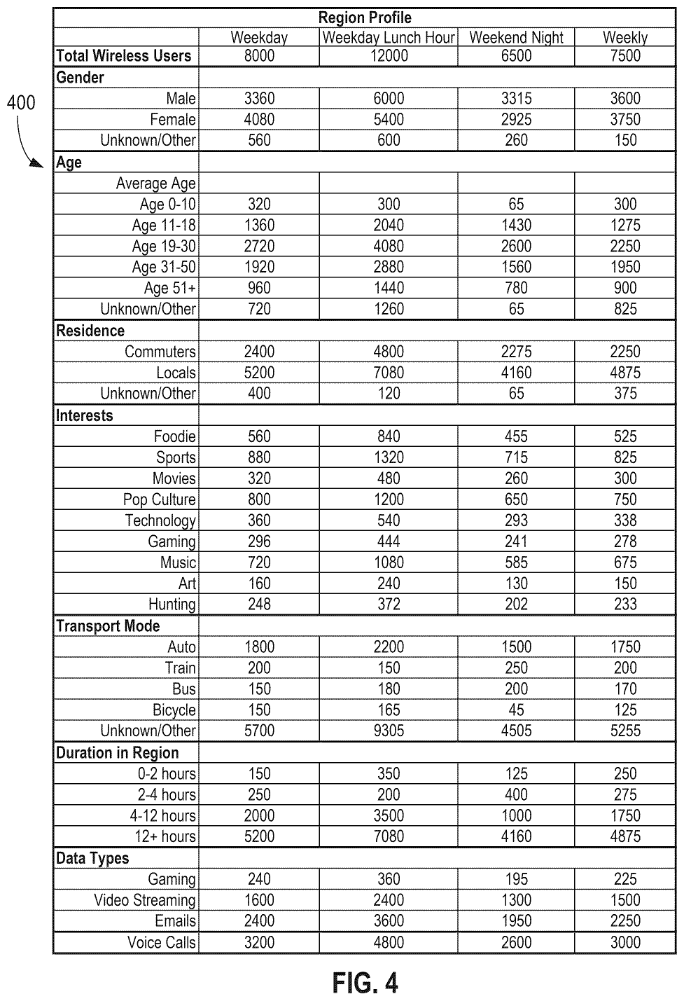

FIG. 4 illustrates an example of a regional profile 400 that may be generated by the process 300. As illustrated, the regional profile 400 provides a first row with a total or average number of wireless devices over a certain time period (e.g., weekday commute, weekday lunch hour, weekend night, or week), and provides classifications of these wireless devices in the rows that follow. In some examples, the certain time period may correspond to the time duration referenced with respect to the process 300. The regional profile 400 corresponds to wireless devices in a geographic area, such as, for example, the geographic region 200 of FIG. 2. The classifications of the wireless devices in the geographic region 200 are according to age, gender, interests, mode of transportation, residence, time spent in the geographic area, and behavior within the geographic area (e.g., in terms of which data type was being communicated or consumed by the wireless device).

While some classifications may be explicitly present in the movement data for a particular wireless device, the artificial intelligence model 185 may determine or infer others of these classifications based on the movement data. For example, the artificial intelligence model 185 may infer that a user of one of the wireless devices is a local resident in the geographic area if the wireless device remains present at a residential house in the geographic area for an extended period of time or each evening over a certain number of days, and may determine that the user is a commuter into the geographic area for work if the wireless device is present in the geographic area during typical work hours on weekdays. In other instances, the inferences performed by the artificial intelligence model 185 to classify wireless devices based on the movement data may be more sophisticated and generally imperceptible to a human based on the movement data. For example, activities of certain commuters and certain locals may be atypical and a biased human observer may not appreciate that such activities indicate that the user is a commuter or is a local based on the movement data, whereas the artificial intelligence model 185 may arrive at such conclusions. Similarly, the artificial intelligence model 185 may classify wireless devices according to interests of the users based on the movement data. Such interests may indicate that the user is particularly interested in different types of food or fine dining, sports, movies, pop culture, technology, gaming, music, art, hunting, among many other types of interests that a user may have. For example, movement data indicating a user frequents certain establishments, consumes certain types of data, takes certain types of transportation, may enable the artificial intelligence model 185 to classify the user as having particular interests. Further, the movement data, particularly location information of the movement data, may enable the artificial intelligence model 185 to classify the user as using particular forms of transportation.

Given the quantities of movement data, particularly when many hundreds or thousands of wireless devices may be in a geographic area, and when complex or imperceptible connections may exist between particular types of movement data and particular classifications, a human cannot practically analyze the movement data to arrive at such classifications as provided by the artificial intelligence model 185.

In some examples, the region covered by the regional profile 400 is a particular location or establishment within the geographic area. For example, the regional profile may be specific to a particular business, facility, or park (e.g., the location 202a, 202b, or 202c in the geographic region 200 of FIG. 2). In such examples, the movement data may correspond to wireless devices that entered into the location 202a, 202b, or 202c, and may exclude wireless devices outside of the location 202a, 202b, or 202 in the geographic region 200 and/or in the larger coverage area of the radio access network 170. Accordingly, such a profile may indicate a classification of a location (or locations) within the geographic region 200 according to demographics of users of the wireless devices at the location(s), time the users of the wireless devices spent at the location(s), mode of transportation to or from the location(s), or foot traffic density at the location(s). In such examples, when the profile 400 is specific to a location or locations within a geographic area, the profile 400 may be referred to a location profile.

In some examples, a profile for a geographic region (e.g., the profile 400 for the geographic region 200) further includes classifications for one or more locations (e.g., locations 202) within the geographic region 200. Accordingly, a profile for a geographic region may further include one or more location profiles that indicate classifications of respective locations (e.g., in addition to classifications for the geographic region overall).

Of course, the regional profile 400 is but one example of a regional profile that the process 300 may generate, and the process 300 may generate other regional profiles having other particular values, information, number of rows, number of columns, organization, and/or visual representations (e.g., graphs, charts of other formats, etc.).

For example, in some examples, the regional profile provided by the controller 136, using the artificial intelligence model 185, may include information such as, for example, predictions, performance metrics for wireless devices communicating in the region using the radio access network 170, patterns, trends, and other information that may be pertinent to the performance of the radio access network 170. Predictions made by the artificial intelligence model 185 may relate to possible future usage or performance of the radio access network 170. For example, the regional profile may indicate a predicted future classification of wireless devices in the radio access network 170 based on the movement data. The artificial intelligence model 185 may, for example, predict classifications (e.g., in the form of a column of the profile 400) for a future day or time period based on movement data for a previous day or time period. In such examples, the artificial intelligence model 185 may be trained, using training data including movement data for earlier time periods and actual classification information for later time periods, to provide such predictions. In some examples, the artificial intelligence model 185 identifies patterns or trends in usage of the radio access network 170 and such patterns or trends are indicated in the regional profile. In such examples, the artificial intelligence model 185 may be trained in an unsupervised manner, using training data that includes batches of example movement data, to identify patterns and trends from movement data.

Returning to FIG. 3, in some examples, the core network 110 and/or the data center system 130 collects movement data over a period of time (e.g., the time duration) and applies this collection of movement data to the artificial intelligence model 185 as the batch of movement data. In such examples, the process 300 may involve applying a single batch of movement data (the movement data collected over the period of time) to the artificial intelligence model 185 to ultimately generate the profile. In such examples, the process 300 may include blocks 340 (where the collection of movement data is received), block 350 (where the collection of movement data is applied to the artificial intelligence model), and block 380 (where the profile is generated).

In some examples, the process 300 may further include training of the artificial intelligence model (e.g., of the artificial intelligence model 185) to analyze the movement data. For example, before the process 300 is first implemented, the artificial intelligence model 185 may be trained to analyze the movement data without human intervention. The training may be, for example, supervised, unsupervised, or a combination thereof, as previously described. In some examples, the process 300 may include further training of the artificial intelligence model 185 to supplement the initial training and update the artificial intelligence model 185. For example, the further training may be based on further batches of movement data received during iterations of the process 300. The further training may, for example, result in refined weights and/or connections between nodes of the artificial intelligence model 185.

The analysis performed by data center system 130 and provided in the regional profile may provide the data center system 130 with valuable information regarding the performance of the radio access network 170 under an assortment of conditions. The assortment of conditions may include the data traffic patterns throughout the telecommunications infrastructure 100 during wireless communication between the radio access network 170 and any user equipment. The assortment of conditions may also include the preferences and demands for a variety of services by subscribers whose user equipment is in wireless communication with the radio access network 170. These variety of services may include, but are not limited to, voice calls, text messaging, internet access, video conferencing, multimedia content delivery, web browsing, media streaming, online gaming, and/or other services.

Based on the regional profile, the data center system 130 may allocate network resources for the radio access network 170 automatically without any human intervention. For example, the data center system 130 may automatically control the allocation of the network resources in real-time when user equipment that is in wireless communication with the radio access network 170 travels from a location in the geographic region the radio access network 170 to other location in the geographic region. These network resources may include, but are not limited to, bandwidth usage by the radio access network 170, power consumption by the radio access network 170, and other resources of the radio access network 170.

Automatically controlling the allocation of network resources in real-time may improve the efficiency of the radio access network 170. The improved efficiency may include, but is not limited to, a reduction in overall bandwidth usage, a latency reduction, a reduction in energy consumption, and a reduction in network communication disruptions. The improved efficiency of the radio access network 170 may enhance the overall performance and maintenance of the radio access network 170, and may also improve the quality of service (QoS) and quality of experience (QoE) that the radio access network 170 may provide to the subscribers. Improving the efficiency of the radio access network 170 by automatically allocating the network resources in real-time is an improvement to the radio access network 170.

Cells in the radio access network 170 may provide overlapping wireless communication coverage throughout adjacent geographic areas in the radio access network 170. Expansion and/or densification of the wireless communication coverage in a geographic area of the radio access network 170 may improve wireless connectivity to the radio access network 170. Improving the wireless connectivity to the radio access network 170 is an improvement to the radio access network 170. The data center system 130 having a capability of automatically controlling the allocation of the network resources is an improvement to the data center system 130.

For a commercial business, improvement of the wireless connectivity to the radio access network 170 in the geographic area may enhance business development and growth opportunities in the geographic area where the wireless communication coverage to the radio access network 170 is improved. The data center system 130, for a fee and/or other valuable consideration from the commercial business, may provide an output of the regional profile to the commercial business.

The predictions in the regional profile may identify geographic areas in the radio access network 170 that are suitable for expansion and/or densification of the wireless communication coverage. The commercial business may analyze the information in the regional profile and establish a virtual or physical presence in the geographic area that the predictions identify as suitable for expansion and/or densification of the wireless communication coverage. The establishment, by the commercial business, of a virtual or physical presence in the geographic area may produce additional revenues to the data center system 130. The additional revenues to the data center system 130 may result in an improvement to physical infrastructure of the data center system 130.

In some examples, aspects of the technology, including computerized implementations of methods according to the technology, may be implemented as a system, method, apparatus, or article of manufacture using standard programming or engineering techniques to produce software, firmware, hardware, or any combination thereof to control a processor, also referred to as an electronic processor, (e.g., a serial or parallel processor chip or specialized processor chip, a single- or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein.

Accordingly, for example, examples of the technology may be implemented as a set of instructions, tangibly embodied on a non-transitory computer-readable media, such that a processor may implement the instructions based upon reading the instructions from the computer-readable media. Some examples of the technology may include (or utilize) a control device such as, e.g., an automation device, a special purpose or programmable computer including various computer hardware, software, firmware, and so on, consistent with the discussion herein. As specific examples, a control device may include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, may be executed in different orders than are expressly illustrated or described, as appropriate for particular examples of the technology. Further, in some examples, certain operations may be executed in parallel or partially in parallel, including by dedicated parallel processing devices, or separate computing device 170s configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer may be a component. A component (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that may be present in any variety of combinations, rather than an exclusive list of components that may be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “only one of,” or “exactly one of” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “only one of,” or “exactly one of.”

In the description above and the claims below, the term “connected” may refer to a physical connection or a logical connection. A physical connection indicates that at least two devices or systems co-operate, communicate, or interact with each other, and are in direct physical or electrical contact with each other. For example, two devices are physically connected via an electrical cable. A logical connection indicates that at least two devices or systems co-operate, communicate, or interact with each other, but may or may not be in direct physical or electrical contact with each other. Throughout the description and claims, the term “coupled” may be used to show a logical connection that is not necessarily a physical connection. “Co-operation,” “the communication,” “interaction” and their variations include at least one of: (i) transmitting of information to a device or system; or (ii) receiving of information by a device or system.

Any mark, if referenced herein, may be common law or registered trademarks of third parties affiliated or unaffiliated with the applicant or the assignee. Use of these marks is by way of example and shall not be construed as descriptive or to limit the scope of disclosed or claimed embodiments to material associated only with such marks.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the application, ordinal numbers (e.g., first, second, third, etc.) may be used as an adjective for an element (i.e., any noun in the application). Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section.

The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application.

Unless otherwise indicated, like parts and method steps are referred to with like reference numerals.

Although the present technology has been described by referring to certain examples, workers skilled in the art will recognize that changes may be made in form and detail without departing from the scope of the discussion.

What is claimed is:

1. A system comprising:
a data port configured to:
receive, from a component of a core network in a telecommunications infrastructure, data that is based on wireless communications of wireless devices over a radio access network in the telecommunications infrastructure; and
a controller configured to:
control, when the data port receives the data, an artificial intelligence model to perform an analysis on the data, and
generate, from a result of the analysis, a profile for a geographic region in the radio access network.

2. The system of claim 1, wherein the data is movement data that includes information that indicates at least one selected from a group of: movement of the wireless devices throughout the geographic region, types and locations of buildings in the geographic region, types of communicated data of the wireless communications, or demographics for users of the wireless devices.

3. The system of claim 1, wherein the profile indicates a classification of users of the wireless devices in the geographic region according to at least one selected from a group of: age, gender, interests, mode of transportation, time spent in the geographic region, or behavior within the geographic region.

4. The system of claim 1, wherein the profile indicates a classification of locations within the geographic region according to at least one selected from a group of: demographics of users of the wireless devices at the locations, time the users of the wireless devices spent at the locations, mode of transportation to or from the locations, or foot traffic density at the locations.

5. The system of claim 1, wherein the controller is configured to:
control, when the data port receives multiple batches of the data, the artificial intelligence model to perform the analysis on the multiple batches; and
generate the profile from the result when the artificial intelligence model analyzes the multiple batches of the data.

6. The system of claim 1, wherein the controller is configured to:
control a reallocation of network resources for the radio access network based on the profile.

7. The system of claim 1, wherein the controller is configured to:
transmit the profile, via the data port, to an external system.

8. The system of claim 1, wherein the controller is configured to:
train, before the data port receives the data, the artificial intelligence model to analyze the data.

9. The system of claim 1, wherein the data port and the controller are integrated into the core network, are at an edge data center in communication with the core network, or are distributed between the core network and the edge data center.

10. A method comprising:
controlling by a controller, a data port to receive from a component of a core network in a telecommunications infrastructure, data that is based on wireless communications of wireless devices over a radio access network in the telecommunications infrastructure;
controlling by the controller, when the data port receives the data, an artificial intelligence model to perform an analysis on the data; and
creating by the controller, from a result of the analysis, a profile for a region in the radio access network.

11. The method of claim 10, wherein the data is movement data that includes information that indicates at least one selected from a group of: movement of the wireless devices throughout the region, types and locations of buildings in the region, types of communicated data of the wireless communications, or demographics for users of the wireless devices.

12. The method of claim 10, wherein the profile indicates a classification of users of the wireless devices in the region according to at least one selected from a group of: age, gender, interests, mode of transportation, time spent in the region, or behavior within the region.

13. The method of claim 10, wherein the profile indicates a classification of locations within the region according to at least one selected from a group of: demographics of users of the wireless devices at the locations, time the users of the wireless devices spent at the locations, mode of transportation to or from the locations, or foot traffic density at the locations.

14. The method of claim 10, the method further comprising:
controlling, when the data port receives multiple batches of the data, the artificial intelligence model to perform the analysis on the multiple batches; and
creating the profile from the result when the artificial intelligence model analyzes the multiple batches of the data.

15. The method of claim 10, further comprising:
transmitting the profile, via the data port, to an external system.

16. A non-transitory computer-readable medium to store machine-readable instructions that, when executed by a controller, cause the controller to:
control a data port to receive, from a core network in a telecommunications infrastructure, data that is based on wireless communications of wireless devices over a radio access network in the telecommunications infrastructure;
control, when the data port receives the data, an artificial intelligence model to perform an analysis on the data; and
generate, from a result of the analysis, a profile for a geographic region in the radio access network.

17. The computer-readable medium of claim 16, wherein the data is movement data that includes information that indicates at least one selected from a group of: movement of the wireless devices throughout the geographic region, types and locations of buildings in the geographic region, types of communicated data of the wireless communications, or demographics for users of the wireless devices.

18. The computer-readable medium of claim 16, wherein the profile indicates a classification of users of the wireless devices in the geographic region according to at least one selected from a group of: age, gender, interests, mode of transportation, time spent in the geographic region, or behavior within the geographic region.

19. The computer-readable medium of claim 16, wherein the profile indicates a classification of locations within the geographic region according to at least one selected from a group of: demographics of users of the wireless devices at the locations, time the users of the wireless devices spent at the locations, mode of transportation to or from the locations, or foot traffic density at the locations.

20. The computer-readable medium of claim 19, wherein the machine-readable instructions, when executed by a controller, cause the controller to:
control, based on the profile, a reallocation of network resources for the radio access network.
